(19) United States
(12) Patent Application Publication
(10) Pub. No.: US 2026/0141674 A1
(43) Pub. Date: May 21, 2026

(54) LOCKER SYSTEM AND LOCKER MANAGEMENT METHOD

(71) Applicant: PixArt Imaging Inc., Hsin-Chu City (TW)

(72) Inventors: Chih-Huan Wu, Hsin-Chu City (TW); Wen-Han Yao, Hsin-Chu City (TW)

(73) Assignee: PixArt Imaging Inc., Hsin-Chu City (TW)

(21) Appl. No.: 19/274,659

(22) Filed: Jul. 21, 2025

Related U.S. Application Data
(60) Provisional application No. 63/721,566, filed on Nov. 18, 2024.

(51) Int. Cl. G06V 10/60; G06V 20/52; G07F 17/12

(52) U.S. Cl. CPC G06V 10/60; G06V 20/52; G07F 17/12

(57) ABSTRACT

A locker system, comprising: a locker, comprising a door; an image sensor, located inside the locker, configured to sense at least one first image in a first time and at least one second image in a second time after the first time, wherein the door is to be opened in the first time and has been closed in the second time; and a processing circuit, configured to determine an object state of an object inside the locker according to a first intensity variation of the first image and the second image. A related locker management method is also disclosed. Thereby the object detection interference caused by light source variation or light leak of the locker can be improved.

### CROSS REFERENCE TO RELATED APPLICATIONS

This application claims the benefit of U.S. Provisional Application No. 63/721,566, filed on Nov. 18, 2024. The content of the application is incorporated herein by reference.

### BACKGROUND OF THE INVENTION

### 1. Field of the Invention

The present invention relates to a locker system and a locker management method, and particularly relates to a locker system and a locker management method which can reduce the interference of light variation on the detection of objects in the locker.

### 2. Description of the Prior Art

In modern society, online shopping is becoming more and more popular, and correspondingly, a self-service pickup system is becoming more and more popular. The self-service pickup system allows users to get their purchased goods by themselves without the assistance of a store staff. Self-service pickup systems usually require a large number of lockers, and these lockers also need to have a determining system that can determine whether there are goods placed in them or whether the goods have been taken out.

However, it may take several days or even longer for the goods to be placed in the locker and then taken out. Therefore, if the determining system is an optical determining system, the state of the light source of the optical determining system during this period of time may change, making the determination of whether the goods have been taken out inaccurate.

Besides, lockers may have ventilation holes to prevent creatures from entering the locker and suffocating, but these ventilation holes may cause light leaks. In addition, the gaps or cracks of the lockers may also cause light leaks. These light leaks may also affect the accuracy of the determining system.

### SUMMARY OF THE INVENTION

One objective of the present invention is to provide a locker system which can reduce the object detection interference caused by light source variation or light leak of the locker.

Another objective of the present invention is to provide a locker management method which can reduce the object detection interference caused by light source variation or light leak of the locker.

One embodiment of the present invention is to provide a locker system, comprising: a locker, comprising a door; an image sensor, located inside the locker, configured to sense at least one first image in a first time and at least one second image in a second time after the first time, wherein the door is to be opened in the first time and has been closed in the second time; and a processing circuit, configured to determine an object state of an object inside the locker according to a first intensity variation of the first image and the second image.

Another embodiment of the present invention is to provide a locker management method, applied to a locker comprising an image sensor provided therein and a door, comprising: (a) the image sensor sensing at least one first image in a first time and at least one second image in a second time after the first time, wherein the door is to be opened in the first time and has been closed in the second time; and (b) determining an object state of an object inside the locker according to a first intensity variation of the first image and the second image.

In view of above-mentioned embodiments, the object detection interference caused by light source variation or light leak of the locker can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a locker system according to one embodiment of the present invention.

FIG. 2 is a schematic diagram illustrating a locker with at least one ventilation hole, according to one embodiment of the present invention.

FIG. 3 is a flow chart illustrating steps for reducing light leak interference, according to one embodiment of the present invention.

FIG. 4 and FIG. 5 are flow charts illustrating detail steps of a locker management method, according to one embodiment of the present invention.

FIG. 6 is a schematic diagram illustrating that the images shown in FIG. 4 and FIG. 5 can be replaced by a subtracting result of a light on image and a light off image.

FIG. 7 is a summarized flow chart of a locker management method, according to one embodiment of the present invention.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

Additionally, in following embodiments, the object may be any type of object, such as goods, packages. Furthermore, the lockers described below are not limited to be applied to a self-service pickup system. For example, the lockers stated below may be applied to a luggage storage system.

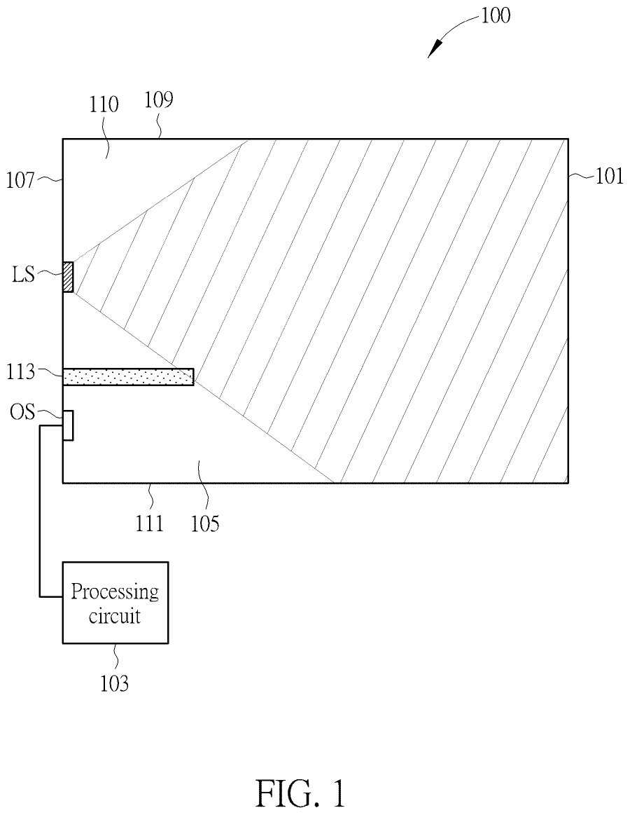

FIG. 1 is a schematic diagram illustrating a locker system 100 according to one embodiment of the present invention. As shown in FIG. 1, the locker system 100 comprises a locker 101, a processing circuit 103, a light source LS and an image sensor OS. The locker system 100 may comprise more than one locker which has components the same as which inside the locker 101, but only one locker 101 is used as an example for explaining. The processing circuit 103 may be a circuit which has computation abilities, such as a micro controller or a CPU. The processing circuit 103 may be provided at any location. For example, the processing circuit 103 may be provided in one of the lockers or be provided in a computer which is used to control the whole locker system 100. In one embodiment, the processing circuit 103 may be incorporated into a CPU which is used to control the whole locker system 100.

The light source LS is located inside the locker 101 and emits light to an inner space 105 of the locker 101. In the embodiment of FIG. 1, the light source LS is located on a side surface 107 of the locker 101. However, the light source LS may be provided at any required location of the locker 101. For example, the light source LS may be provided at a top surface 109 of the locker 101 or at a corner 110 of the locker 101. The image sensor OS is also located inside the locker 101, to sense images of the inner space 105. The image may be sensed when the light source LS is on and may be sensed when the light source LS is off. In one embodiment, the image sensor OS is an image sensor thus the image is at least one image. The processing circuit 103 is configured to determine a light source condition of the light source LS or a locker condition of the locker 101 according to the image.

In the embodiment of FIG. 1, the locker 101 further comprises a bottom surface 111. The side surface 107 is connected with the top surface 109 and the bottom surface 111. Also, a light blocking structure 113 is provided on the side surface 107 and between the light source LS and the image sensor OS, to prevent the image sensor OS from being interfered by the light emitted from the light source LS.

In the above-mentioned embodiment, the light source LS is provided above the image sensor OS. However, in another embodiment, the light source LS maybe provided below the image sensor OS, and the light blocking structure 113 may still be provided between the light source LS and the image sensor OS in such case.

The processing circuit 103 may determine whether an object is put into or taken out from the locker 101 according to the images sensed by the image sensor OS. For example, an image of an empty locker 101 may be recorded in advance, and then after a user opens the locker 101 and places at least one object into the locker 101, an image of the locker 101 with the object therein may be acquired. Afterwards, the image difference between the two images is obtained thereby it can be determined that at least one object is placed in the locker 101. On the contrary, if an image of a locker 101 with at least one object is obtained first, and then an image of a locker 101 without objects or with a reduced number of objects is obtained, after subtracting the two images, it can be determined that at least one of the object in the locker 101 has been taken away. However, the detection of the object may be interfered by some reasons, such as light leaks.

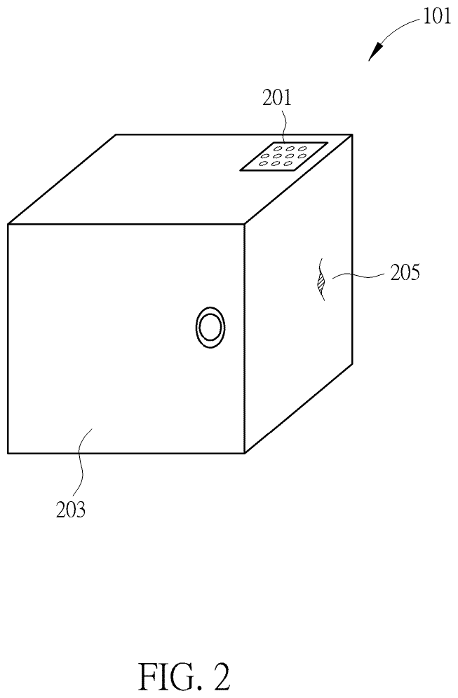

In some embodiments, the locker may have at least one ventilation hole. FIG. 2 is a schematic diagram illustrating a locker 101 with at least one ventilation hole, according to one embodiment of the present invention. In the embodiment of FIG. 2, the locker 101 comprises at least one ventilation hole 201 and a door 203. Further, the locker 101 may have at least one crack such as the crack 205 if the locker 101 is used for a long time or is hit. The ventilation hole 201 or the crack 205 may cause light leaks. However, such light leaks may cause wrong detection of the object. Accordingly, a method of improving such problem is also disclosed in the present invention.

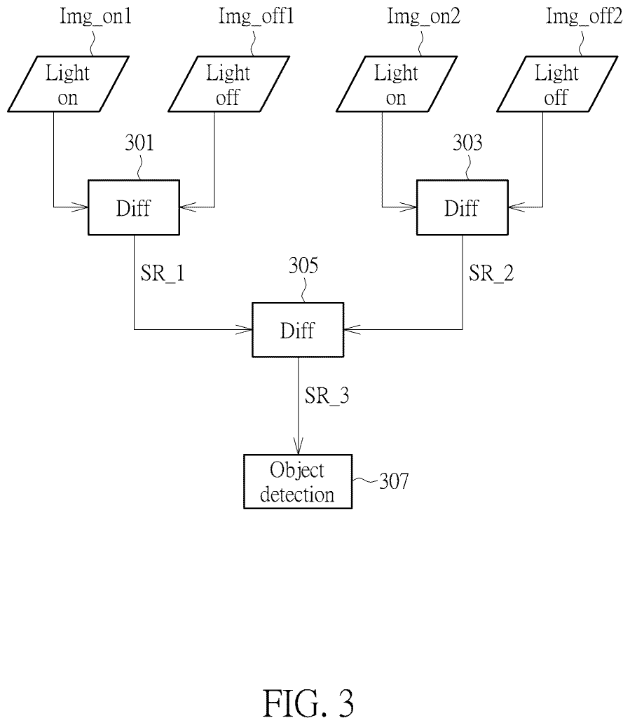

FIG. 3 is a flow chart illustrating steps for reducing light leak interference, according to one embodiment of the present invention. In the embodiment of FIG. 3, a first light on image Img_on1, a first light off image Img_off1, a second light on image Img_on2, a second light off image Img_off2 are sensed by the image sensor OS. The first light on image Img_on1 and the second light on image Img_on2 mean the images sensed while the light source LS emitting light. On the contrary, the first light off image Img_off1 and the second light off image Img_off2 are sensed when no light source in the locker 101 (the light source LS is also included) emits light. In one embodiment, the first light on image Img_on1 and the first light off image Img_off1 are sensed when the door 203 of the locker 101 is being opened (e.g., a command of opening the door is triggered). Further, the second light on image Img_on2 and the second light off image Img_off2 are sensed while the door of the locker 101 has been closed. Indication signals indicating that the door is being opened or has been closed may be generated by, for example, the processing circuit 103 which controls the locker system, to trigger the images sensor OS to sense the first light on image Img_on1, the first light off image Img_off1, the second light on image Img_on2, and the second light off image Img_off2.

However, the generation of the first light on image Img_on1, the first light off image Img_off1, the second light on image Img_on2, and the second light off image Img_off2 are not limited to be triggered by the indication signals.

In the embodiment of FIG. 3, the steps S301, S303 and S305 are respectively subtracting steps. The step S301 generates a subtraction result SR_1 (i.e., image difference) of the first light on image Img_on1 and the first light off image Img_off1, and the step S303 generates a subtraction result SR_2 of the second light on image Img_on2 and the second light off image Img_off2. The first light off image Img_off1 and the second light off image Img_off2 may represent the interference caused by light leaks, since they are sensed when no light source in the locker 101 emits light. Accordingly, in the subtracting result SR_1, the interference caused by light leaks in the first light on image Img_on1 is reduced or removed. Similarly, in the subtracting result SR_2, the interference caused by light leaks in the second light on image Img_on2 is reduced or removed. Afterwards, in the step S305, the subtracting result SR_1 is subtracted with the subtracting result SR_2 to acquire a subtracting result SR_3. After that, the processing circuit 103 determines an object state of the object inside the locker 101 according to the subtracting result SR_3.

The above-mentioned indication signal can be used to avoid interference caused by the light source LS. For example, the embodiment of FIG. 3 can be regarded as: Based on the indication signal, the image sensor OS senses a first optical signal (e.g., the subtracting result SR_1) before the door is opened and senses a second optical signal (e.g., the subtracting result SR_2) after the door has been closed. After that, an object state of the object inside the locker 101 can be determined by the processing circuit 103 according to the first optical signal and the second optical signal.

The sequence of sensing the first light on image Img_on1, the first light off image Img_off1, the second light on image Img_on2 and the second light off image Img_off2 is not limited to: the first light on image Img_on1→the first light off image Img_off1→the second light on image Img_on2→the second light off image Img_off2. In one embodiment, since a time interval between fully turn on to fully turn off of a light source is longer than a time interval between fully turn off to fully turn on of a light source. Accordingly, in one embodiment, the sequence can be changed to the first light on image Img_on1→the first light off image Img_off1→the second light off image Img_off2→the second light on image Img_on2. By this way, the time difference between the sensing of the first light on image Img_on1, the first light off image Img_off1 and the sensing of the second light on image Img_on2, the second light off image Img_off2 can be reduced.

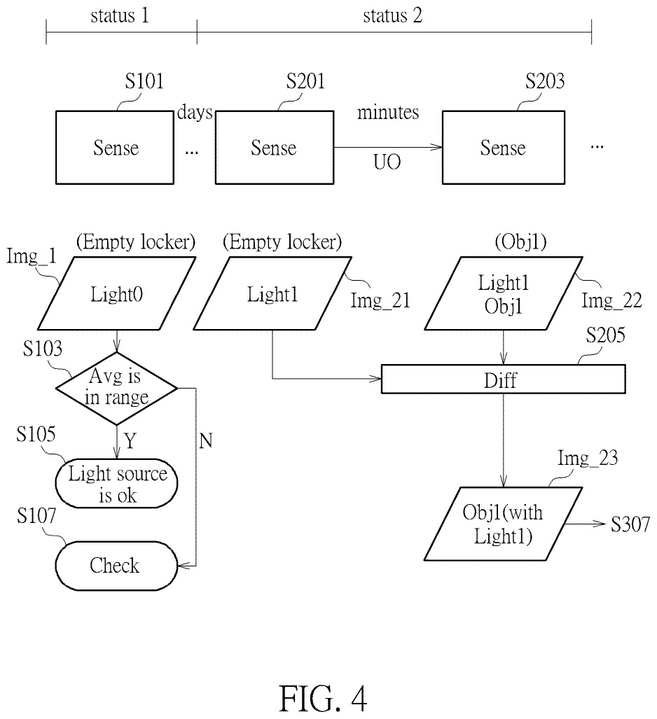

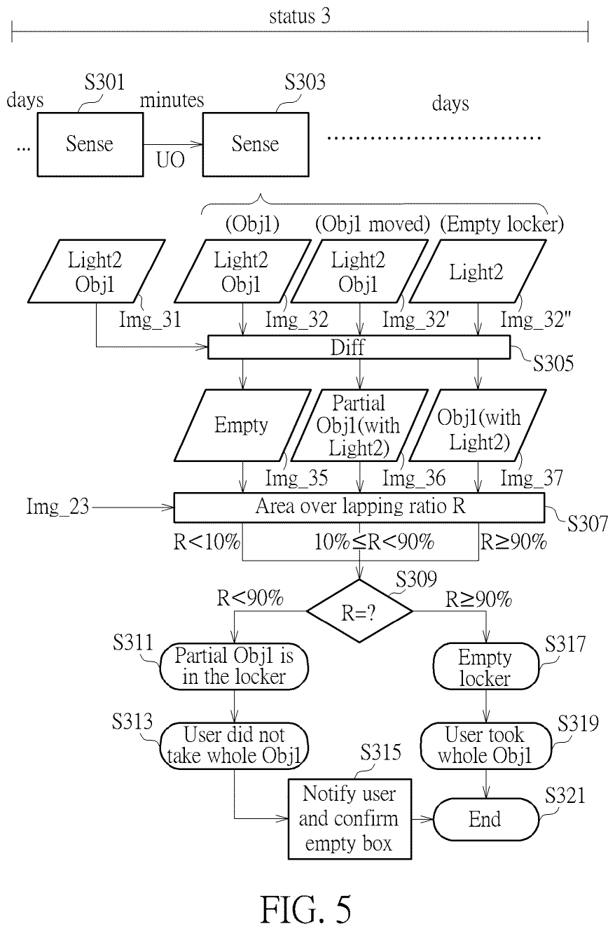

As above-mentioned, the light emitted from the same light source may change after a period of time passes by. Specifically, the light intensity of the light of the same light source may attenuate when the light source operates on the same driving current, after a period of time passes by. Therefore, the embodiments which can improve such issue are also disclosed. FIG. 4 and FIG. 5 are flow charts illustrating detail steps of a locker management method, according to one embodiment of the present invention. In FIG. 4, status 1 means initial setting. For example, a locker with a light source such as the locker 101 that was never used is now in use. In such case, an image Img_1, which is sensed while the light source emitting initial light light0, is sensed in the step S101. After that, determine whether the average brightness of the image Img_1 is within the range in the step S103. If the average brightness is in the range, go to step S105, which means the light source is ok. On the opposite, if the average brightness isn't in the range, go to the step S107, which means the light source may need to be checked.

Besides, in the embodiment of FIG. 4, it is assumed that the status 2 is several days after the status 1. Also, it is assumed that the light emitted from the light source changes from light0 to light1 in the status 2. In the status 2, an image Img_21 is sensed in the step S201 under the light1. In the step S201, a door of the locker is to be opened. The image Img_21 is an image of an empty locker, which means no object is put in by a user yet. Then, a user performs a user operation (UO) in minutes. The user operation in the status 2 means at least one object Obj1 is put into the locker. After that, an image Img_22 is sensed in the step S203 under the light1, and comprises an object image of at least one object obj1. The step S203 means the user has closed the door. Further, in the step S205, the image Img_21 and the image Img_22 are subtracted to generate an image Img_23, which means the object image of the object Obj1. Please note, the image Img_23 may be a subtracting result of the image Img_21 and the image Img_22, but can be a binarization result of such subtracting result as well.

In the embodiment of FIG. 5, it is assumed that the status 3 is several days after the status 2. Also, it is assumed that the light emitted from the light source changes from light1 to light2 in the status 3. In the status 3, an image Img_31 is sensed in the step S301 under the light2. In the step S301, a door of the locker is to be opened. The image Img_31 is an image with an object image of the object Obj1. Then, a user performs a user operation UO in minutes. The user operation in status 3 means at least one object Obj1 is taken out from the locker or moved, or none of the object Obj1 is removed or moved. After that, an image sensed is sensed in the step S303 under the light2. The step S303 means the user has closed the door. Please note, in FIG. 5, the image Img_32, the image Img_32′ and the image Img_32″ mean the same image which is sensed in the step S303, but have different contents.

In other words, the image Img_32, the image Img_32′ and the image Img_32″ are images for different scenarios and only one of the image Img_32, the image Img_32′ and the image Img_32″ may exists for one image generation. In one scenario, the image _31 is generated and then the Image_32 is generated but the images_32′, image_32″ are not generated. In another scenario, the image _31 is generated and then the Image_32′ is generated but the images_32, image_32″ are not generated.

In the image Img_32, none of the object Obj1 is removed, thus if the image Img_32 is subtracted with the image Img_31, an image Img_35 which means an empty image is acquired, since the image Img_31 and the image Img_32 have the same contents.

In the image Img_32′, only a portion of the object Obj1 is removed or moved, thus if the image Img_32′ is subtracted with the image Img_31, an image Img_36 which means an image with an object image for that a portion of objects Obj1 have been changed (moved or removed) is acquired. In the image Img_32″, all of the object Obj1 are removed, thus if the image Img_32″ is subtracted with the image Img_31, an image Img_37 which means an image with object images for all objects can be acquired. The images Img_35, Img_36 and Img_37 may be a subtracting result of the step S307, but can be a binarization result of such subtracting result as well.

In the step S307, an area overlapping ratio R between the image Img_23, and one of the image Img_35, the image Img_36 and the image Img_37 is calculated. The area overlapping ratio R between the image Img_23 and the image Img_35 is very small, for example, smaller than 10%, since the image Img_23 is an object image but the image Img_35 is an empty image. Also, the area overlapping ratio R between the image Img_23 and the image Img_36 is in a specific range, for example, 10%-90%, since the image Img_23 is an object image and the image Img_36 is an object image for a portion of the object Obj1. Further, the area overlapping ratio R between the image Img_23 and the image Img_37 is high, for example, over 90%, since the image Img_23 is an object image for all object Obj1 and the image Img_37 is also an object image for all object Obj1.

After the area overlapping ratio R is acquired, the object state may be determined according to the area overlapping ratio R, in the step S309. If the area overlapping ratio R is smaller than a predetermine value, such as 90%, it is determined that at least a portion of the object Obj1 is in the locker, as stated in the step S311. Accordingly, it is determined that the user did not take out all object Obj1, as stated in the step S313. Therefore, in the step S315, a message is generated to notify the user to confirm, that is, notify the user to check if all object Obj1 is taken out from the locker. On the contrary, if the area overlapping ratio R is larger than the predetermine value, it is determined that the user has taken out all of the object Obj1, thus the locker is empty, as stated in the steps S317 and S319.

Please note, in the embodiments of FIG. 4, FIG. 5, directly sensed images such as images Img_21, Img_22, Img_23 . . . are used as examples for explaining. However, these images can be replaced by the image difference or the subtracting results stated in FIG. 2. For example, the image Img_21 can be replaced by a subtracting result of a light on image and a light off image, and other images stated in FIG. 4 and FIG. 5 can follow such rule.

For more detail, in order to reduce interference caused by light leakage or variation of the light source. The images shown in FIG. 4 and FIG. 5 can be replaced by a subtraction result of a light on image and a light off image which are generated in a short time interval.

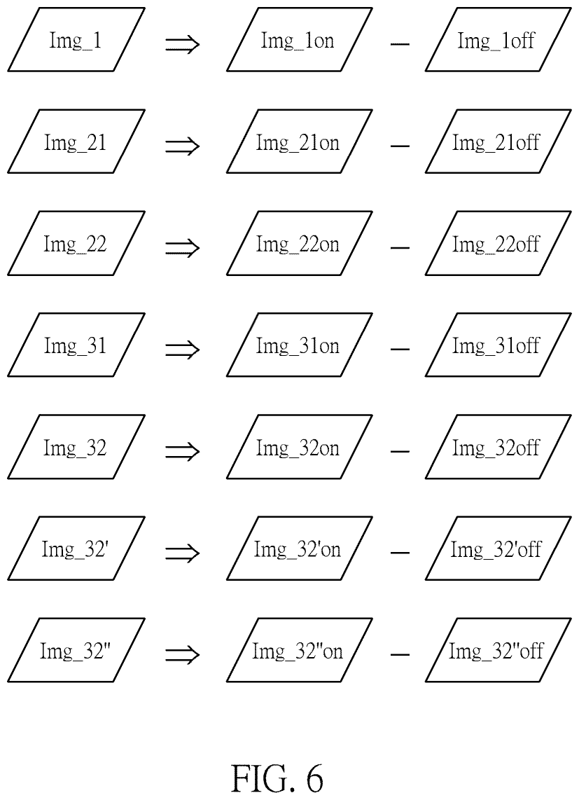

FIG. 6 is a schematic diagram illustrating that the images shown in FIG. 4 and FIG. 5 can be replaced by a subtracting result of a light on image and a light off image. As shown in FIG. 6, the image Img_1 in FIG. 4 can be replaced by a subtracting result of a light on image Img_1on and a light off image Img_1off. Also, the image Img_21 in FIG. 4 can be replaced by a subtracting result of a light on image Img_21on and a light off image Img_21off. Some other images shown in FIG. 4 and FIG. 5 can be respectively replaced by a subtracting result of a light on image and a light off image, as shown in FIG. 6.

In one embodiment, the steps S205 and S305 may be replaced by a division step. In such case, the division result means a brightness information variation ratio. If the brightness information variation ratio is smaller than a brightness information threshold(e.g., 1.02), the division result (the image Img_23 and the images Img_35, Img_36 and Img_37) is ignored and not used to determine the object state, since the image variation may be caused by the light variation of the light source occurs in a short time (e.g., minutes in FIG. 4 and FIG. 5).

After the status 3, at least portion steps of the status 2 or 3 can be performed again to check the object state, no matter whether the locker is empty or not. Please note, the steps in the locker management method provided by the present invention is not limited to the sequence shown in FIG. 4 and FIG. 5, any variation of the steps based on the disclosed concept of FIG. 4 and FIG. 5 should also fall in the scope of the present invention.

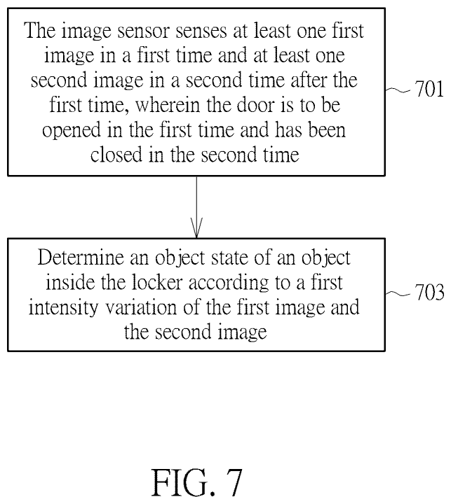

In view of above-mentioned embodiments, a locker management method can be acquired, which is applied to a locker comprising an image sensor provided therein and a door. The locker management method comprises the steps illustrated in FIG. 7. The locker management method can be performed, for example, the locker system 100 illustrated in FIG. 1, but not limited.

### Step 701

The image sensor senses at least one first image in a first time and at least one second image in a second time after the first time, wherein the door is to be opened in the first time and has been closed in the second time.

In the step 701, the first image may mean, for example, the image Img_21, or the image Img_31 in FIG. 4 and FIG. 5. Further, the second image may mean, for example, the image Img_22, or the image Img_32, Img_32′ or Img_32″ in FIG. 4 and FIG. 5.

### Step 703

Determine an object state of an object inside the locker according to a first intensity variation of the first image and the second image.

In one embodiment, the object is in the locker in a time interval between the first time and the second time. For example, the object is in the locker between the step S201 and the step S203 in FIG. 4.

In one embodiment, the image sensor further senses at least one third image in a third time and at least one fourth image in a fourth time after the third time, wherein the door is to be opened in the third time, wherein the door has been closed in the fourth time; wherein the third time and the fourth time are behind the first time and the second time. In such case, the first image may mean the image Img_21 and the second image may mean the image Img_22. Further, the third image may mean the image Img_31 and the fourth image may mean one of the image Img_32, the image Img_32′ and the image Img_32″. In such embodiment, the step 703 determines the object state according to a relation of a first intensity variation of the first image and the second image and a second intensity variation of the third image and the fourth image. In one embodiment, the relation is the above-mentioned area overlapping ratio R. In one embodiment, the step 703 determines whether the object is totally removed, or is partially removed, or is moved according to the relation, such as the steps S309, S311, S313, S315, S317 and S319 in FIG. 5.

In one embodiment, the first intensity variation is a subtraction result of the first image and the second image, and the second intensity variation is a subtraction result of the third image and the fourth image, as shown in the embodiments of FIG. 4 and FIG. 5.

Further, in another embodiment, the first intensity variation is a division result of the first image and the second image, and the second intensity variation is a division result of the third image and the fourth image. In such case, the first intensity variation may be used to determine a brightness information variation ratio between the first image and the second image. In one embodiment, the first image and the second image which correspond to the brightness information variation ratio smaller than a brightness variation threshold are not used to determine the object state. Following the same rule, the second intensity variation may be used to determine a brightness information variation ratio between the third image and the fourth image. In one embodiment, the third image and the fourth image which correspond to the brightness information variation ratio smaller than a brightness variation threshold are not used to determine the object state.

As stated above, in the embodiments of FIG. 4, FIG. 5, directly sensed images such as images Img_21, Img_22, Img_23...are used as examples for explaining. However, these images can be replaced by the subtracting results (the image difference) stated in FIG. 2. Accordingly, the locker management method may further comprise: a light on image and a light off image, and the second image comprises a second light on image and a second light off image, wherein the step 703 determines the object state according to a subtraction result of the light on image and the light off image and a subtraction result of the second light on image and the second light off image.

In view of above-mentioned embodiments, the object detection interference caused by light source variation or light leak of the locker can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A locker system, comprising:
a locker, comprising a door;
an image sensor, located inside the locker, configured to sense at least one first image in a first time and at least one second image in a second time after the first time, wherein the door is to be opened in the first time and has been closed in the second time; and
a processing circuit, configured to determine an object state of an object inside the locker according to a first intensity variation of the first image and the second image.

2. The locker system of claim 1, wherein the first image comprises a first light on image and a first light off image, and the second image comprises a second light on image and a second light off image, wherein the processing circuit determines the object state according to a subtraction result of the first light on image and the first light off image and a subtraction result of the second light on image and the second light off image.

3. The locker system of claim 2, wherein the second light off image is generated before the second light on image.

4. The locker system of claim 1,
wherein the image sensor further senses at least one third image in a third time and at least one fourth image in a fourth time after the third time, wherein the door is to be opened in the third time, wherein the door has been closed in the fourth time;
wherein the third time and the fourth time are behind the first time and the second time;
wherein the processing circuit determines the object state according to a relation of a first intensity variation of the first image and the second image and a second intensity variation of the third image and the fourth image.

5. The locker system of claim 4, wherein the first intensity variation is a subtraction result of the first image and the second image, and the second intensity variation is a subtraction result of the third image and the fourth image.

6. The locker system of claim 4, wherein the first intensity variation is a division result of the first image and the second image, and the second intensity variation is a division result of the third image and the fourth image;
wherein the second intensity variation is used for determining a brightness information variation ratio between the first image and the second image;
wherein the first image and the second image which correspond to the brightness information variation ratio smaller than a brightness variation threshold are not used to determine the object state.

7. The locker system of claim 6,
wherein the first intensity variation is used for determining a brightness information variation ratio between the third image and the fourth image;
wherein the third image and the fourth image which correspond to the brightness information variation ratio smaller than a brightness variation threshold are not used to determine the object state.

8. The locker system of claim 4, wherein the relation is an area overlapping ratio, and wherein the object is in the locker in a time interval between the first time and the second time, wherein the processing circuit determines whether the object is totally removed, or is partially removed, or is moved according to the relation.

9. A locker management method, applied to a locker comprising an image sensor provided therein and a door, comprising:
(a) the image sensor sensing at least one first image in a first time and at least one second image in a second time after the first time, wherein the door is to be opened in the first time and has been closed in the second time; and
(b) determining an object state of an object inside the locker according to a first intensity variation of the first image and the second image.

10. The locker management method of claim 9, wherein the first image comprises a first light on image and a first light off image, and the second image comprises a second light on image and a second light off image, wherein the step (b) determines the object state according to a subtraction result of the first light on image and the first light off image and a subtraction result of the second light on image and the second light off image.

11. The locker management method of claim 10, wherein the second light off image is generated before the second light on image.

12. The locker management method of claim 9,
wherein the image sensor further senses at least one third image in a third time and at least one fourth image in a fourth time after the third time, wherein the door is to be opened in the third time, wherein the door has been closed in the fourth time;
wherein the third time and the fourth time are behind the first time and the second time;
wherein the step (b) determines the object state according to a relation of a first intensity variation of the first image and the second image and a second intensity variation of the third image and the fourth image.

13. The locker management method of claim 12, wherein the first intensity variation is a subtraction result of the first image and the second image, and the second intensity variation is a subtraction result of the third image and the fourth image.

14. The locker management method of claim 12, wherein the first intensity variation is a division result of the first image and the second image, and the second intensity variation is a division result of the third image and the fourth image.

15. The locker management method of claim 14, further comprising:
using the first intensity variation to determine a brightness information variation ratio between the first image and the second image; and
not using the first image and the second image which correspond to the brightness information variation ratio smaller than a brightness variation threshold to determine the object state.

16. The locker management method of claim 14,
using the second intensity variation to determine a brightness information variation ratio between the third image and the fourth image;
not using the third image and the fourth image which correspond to the brightness information variation ratio smaller than a brightness variation threshold to determine the object state.

17. The locker management method of claim 12, wherein the relation is an area overlapping ratio.

18. The locker management method of claim 17, wherein the object is in the locker in a time interval between the first time and the second time, wherein the step (b) determines whether the object is totally removed, or is partially removed, or is moved according to the relation.

19. A locker system, comprising:
a locker, comprising a door;
a processing circuit, configured to generate an indication signal indicating that the door is being opened or has been closed; and
an image sensor, configured to sense a first optical signal before the door is opened and senses a second optical signal after the door has been closed;
wherein the processing circuit determines an object state of an object inside the locker according to the first optical signal and the second optical signal.

20. The locker system of claim 19, wherein the first optical signal is generated according to variation between a first light on image and a first light off image, and the second optical signal is generated according to variation between a second light on image and a second light off image.
